(19) United States
(12) Patent Application Publication
(10) Pub. No.: US 2016/0095303 A1
(43) Pub. Date: Apr. 7, 2016

(54) ELECTRONIC INSECT BARRIER

(71) Applicant: Richard K. Bronk, Shenandoah, PA (US)

(72) Inventor: Richard K. Bronk, Shenandoah, PA (US)

(21) Appl. No.: 14/966,852

(22) Filed: Dec. 11, 2015

Related U.S. Application Data
(63) Continuation-in-part of application No. 13/884,955, filed on May 11, 2013.

(51) Int. Cl. A01M 1/22; A47C 31/00; A01M 1/10

(52) U.S. Cl. CPC A01M 1/223; A01M 1/103; A47C 31/007

(57) ABSTRACT

Electronic insect barriers are presented including: a base defined by an edge; a perimeter barrier extending upwardly from the base, the perimeter barrier located inward of the edge; a removable cover that defines a trap cavity and defines an inside opening, where the removable cover extends upwardly from the base starting inward of and along the perimeter barrier, where the removable cover extends outwardly toward the edge, and where the removable cover extends downwardly toward the base terminating at a hanging edge outward of and along the perimeter barrier; a number of electrodes located at least along the base inward of the perimeter barrier and within the trap cavity; and an inner barrier extending upwardly from the base, the inner barrier located inward of the removable cover, the inner barrier defining a space for receiving a furniture leg.

### CROSS-REFERENCE TO RELATED APPLICATIONS

The present invention is related to the following applications, all of which are incorporated herein by reference:

This application is a continuation-in-part of commonly owned co-pending U.S. patent application Ser. No. 13/884,955, filed on May 11, 2013.

### BACKGROUND

The present application relates to devices for creating insect barriers and more particularly for creating a bed bug barrier between the floor and the bed.

Reports of bedbug infestations continue to rise since about 1995 and numerous systems have been used to rid a home of an infestation. The most common type of bedbug is Cimex lectularius. The term usually refers to species that prefer to feed on human blood. All insects in this family live by feeding exclusively on the blood of warm-blooded animals. Bed bugs, though not strictly nocturnal, are mainly active at night and are capable of feeding unnoticed on their hosts.

Pesticides that have historically been found to be effective include: pyrethroids, dichlorvos and malathion. Resistance to pesticides has increased significantly over time and there are concerns of negative health effects from their use. More recently, in the United States, the Environmental Protection Agency (EPA) has become involved in indoor use of chemicals, reducing, limiting and in some instances banning there use because of potential toxicity to children after chronic exposure to some chemicals.

Mechanical approaches such as traps, coasters, vacuuming up the insects and heat treating or wrapping mattresses have been recommended to keep bedbugs from entering the bed. The problem with these mechanical systems, however, is that they are not entirely effective.

As such, electronic insect barriers are presented herein.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, electronic insect barriers are presented including: a base defined by an edge; a perimeter barrier extending upwardly from the base, the perimeter barrier located inward of the edge; a removable cover that defines a trap cavity and defines an inside opening, where the removable cover extends upwardly from the base starting inward of and along the perimeter barrier, where the removable cover extends outwardly toward the edge, and where the removable cover extends downwardly toward the base terminating at a hanging edge outward of and along the perimeter barrier; a number of electrodes located at least along the base inward of the perimeter barrier and within the trap cavity; and an inner barrier extending upwardly from the base, the inner barrier located inward of the removable cover, the inner barrier defining a space for receiving a furniture leg. In some embodiments, the number of electrodes are interleaved with a number of insulators. In some embodiments, some of the number of electrodes are located along the perimeter barrier. In some embodiments, barriers further include a power unit that creates an electrical potential between pairs of the number of electrodes. In some embodiments, the electrical potential is in a range of approximately 1500 to 2000 VDC. In some embodiments, the electrical potential is approximately 1700 VDC. In some embodiments, the hanging edge terminates at least approximately 1.0 inch from the base. In some embodiments, the hanging edge terminates at least approximately 1.0 inch from the perimeter barrier. In some embodiments, a top edge of the perimeter barrier terminates at least approximately 1.0 inch from a bottom surface of the removable cover. In some embodiments, the space defined by the inner barrier has an open cross-section of at least approximately 4.0 inches.

In other embodiments insect resistant beds are presented including: a bed having a number of bed legs; and a number of electronic insect barriers positioned along each of the of bed legs, each electronic insect barrier including: a base defined by an edge, a perimeter barrier extending upwardly from the base, the perimeter barrier located inward of the edge, a removable cover that defines a trap cavity and defines an inside opening, where the removable cover extends upwardly from the base starting inward of and along the perimeter barrier, where the removable cover extends outwardly toward the edge, and where the removable cover extends downwardly toward the base terminating at a hanging edge outward of and along the perimeter barrier; a number of electrodes located at least along the base inward of the perimeter barrier and within the trap cavity, and an inner barrier extending upwardly from the base, the inner barrier located inward of the removable cover, the inner barrier defining a space for receiving one of the number of bed legs.

In other embodiments, methods for preventing crawling insects from entering a bed are presented including: providing a bed having a number of bed legs; and providing a number of electronic insect barriers each positioned along a bottom of each of the number of bed legs, where each of the number of electronic insect barriers include, a base defined by an edge, a perimeter barrier extending upwardly from the base, the perimeter barrier located inward of the edge, a removable cover that defines a trap cavity and defines an inside opening, where the removable cover extends upwardly from the base starting inward of and along the perimeter barrier, where the removable cover extends outwardly toward the edge, and where the removable cover extends downwardly toward the base terminating at a hanging edge outward of and along the perimeter barrier; a number of electrodes located at least along the base inward of the perimeter barrier and within the trap cavity, and an inner barrier extending upwardly from the base, the inner barrier located inward of the removable cover, the inner barrier defining a space for receiving one of the number of bed legs. In some embodiments, methods further include: shocking the crawling insect when the crawling insect touches a pair of the number of electrodes. In some embodiments, methods further include: lifting the removable cover to access the trap cavity; and cleaning the trap cavity.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 is a perspective view of a device for preventing bed bugs from crawling from the floor to the bed according to one embodiment;

FIG. 2 is a perspective view of a device for preventing bed bugs from crawling from the floor to the bed according to one embodiment;

FIG. 3 is a perspective view of a device for preventing bed bugs from crawling from the floor to the bed according to one embodiment;

FIG. 4 is a cross section view taken from FIG. 3 of a device for preventing bed bugs from crawling from the floor to the bed according to one embodiment;

FIGS. 5 and 5A-5D show a schematic diagram of the device electronic circuit;

FIG. 6 is a top view of one embodiment of a device conductor;

FIG. 7 is a top view of one embodiment of a device insulator;

FIG. 8 is a perspective view of a device for preventing bed bugs from crawling from the floor to the bed according to one embodiment;

FIG. 9 is a cross section view taken from FIG. 8 of a device for preventing bed bugs from crawling from the floor to the bed according to one embodiment;

FIG. 10 is an illustrative representation of an electronic insect barrier in accordance with embodiments of the present invention;

FIG. 11 is an illustrative representation of an electronic insect barrier with removable cover off in accordance with embodiments of the present invention;

FIG. 12 is an illustrative representation of an electronic insect barrier with removable cover off in accordance with embodiments of the present invention;

FIG. 13 is an illustrative representation of a cross-sectional view of an electronic insect barrier with removable cover in accordance with embodiments of the present invention; and

FIG. 14 is an illustrative schematic diagram of a device electronic circuit in accordance with embodiments of the present invention.

### DETAILED DESCRIPTION

The terms “certain embodiments”, “an embodiment”, “embodiment”, “embodiments”, “the embodiment”, “the embodiments”, “one or more embodiments”, “some embodiments”, and one “embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

The device of the present application is designed to kill crawling insects 30 more specifically it targets bed bugs 30. That is, the electronic insect barrier 10 is designed to surround a bed leg 14 and intersects the path bedbugs 30 most typically take to egress a bed. In their path of travel. the insects 30 or bed bugs 30 enter an individual unit 12 through the crawl holes 36 or opening 32 and crawl over electrified metallic conductors 18 that kill them on contact. Alternatively, crawl holes 36 may be a continuous opening around the perimeter of the individual units 12. In this instance, the opening 36 may be continuous to give insects 30 less access to crawl up housing 16 toward opening 32. The device uses a power source such as alternating or direct current, AC and/or DC. and an electronic circuit 24 as an electrocution means. In one embodiment the electronic insect barrier 10 has an input voltage of 12 volts DC and an output voltage of 2,400 volts DC to kill insects 30 and more specifically bedbugs 30.

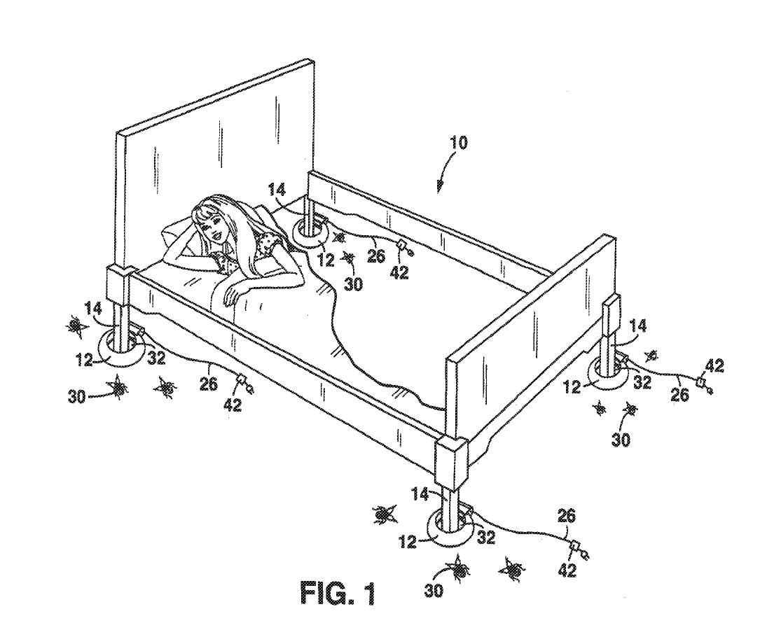

Referring to FIG. 1 the electronic insect barrier 10 consists of individual units 12 used to surround each of the typically four bed legs 14. More units 12 may be used to accommodate beds that have five, six. or more bed legs 14. Each unit has a housing 16 or container that surrounds/creates a barrier around the bed leg 14. The housing 16 may be made of any material, but is preferably made from plastic. it is about 1 to 4 inches tall. is circular in shape, and the diameter is about 4 to 10 inches. The housing 16 is preferably made of one or more components. to shelter the conductors 18 for safety. to prevent bedding material from falling into the device, and to prevent people and pets from making contact with the conductors 18. This housing 16 has an about 2-8 inch diameter opening 32 with circular shape to accommodate the bed leg 14.

The housing 16 further includes a base 22 that will receive the weight of the bed leg 14, passing through the housing 16. The bed leg 14 is bounded by the bed leg anchor 34, attached to base 22. The purpose of the bed leg anchor 34 is to prevent the bed leg 14 from coming into contact with conductors 18. Another purpose of the bed leg anchor 34 is to assist in maintaining a distance of no less than one inch between the bed leg 14 and the perimeter of opening 32, inhibiting the jumping of bedbugs 30 from the housing 16 to the bed leg 14. The housing 16 and the base 22 may be connected with an arced or tubular housing 16 wall, as shown in the drawings. The housing 16 may be removably coupled to the base 22, for example, for cleaning. The housing 16 may alternatively or additionally be connected to the base 22 with a plurality of columns. The columns may be located within the perimeter of the conductors 18. In this respect, bugs entering the crawl hole or holes 36 cannot climb up the columns without first being exposed to the conductors 18. The columns may also serve to locate the conductors 18 within the housing 16.

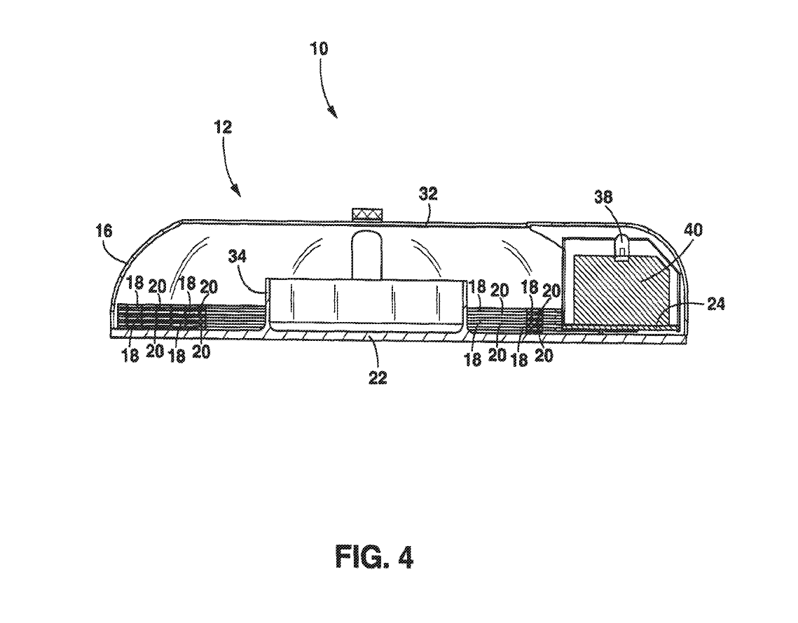

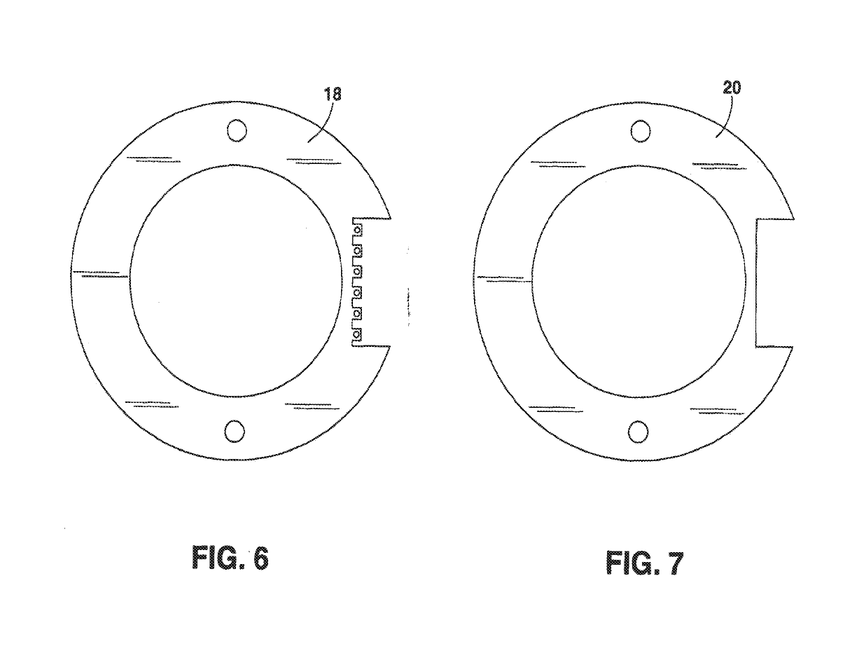

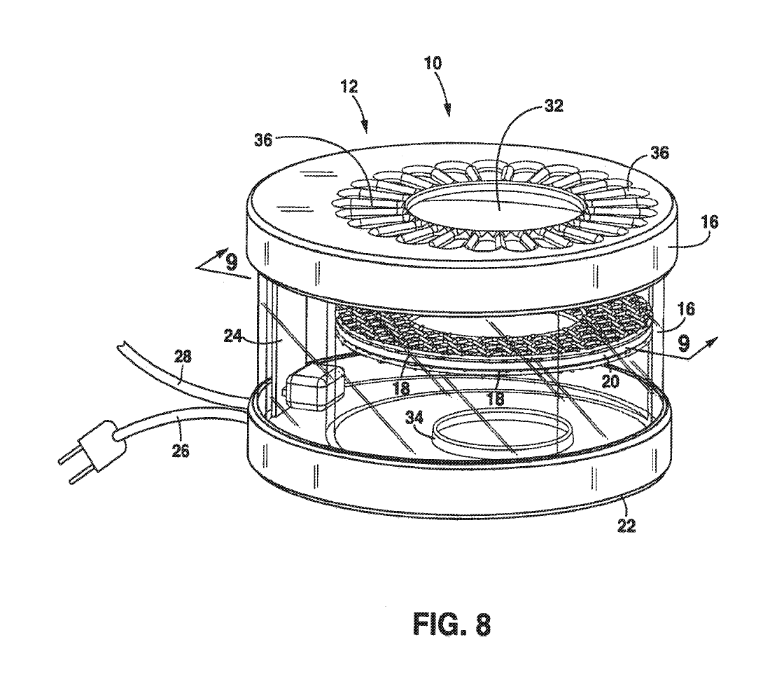

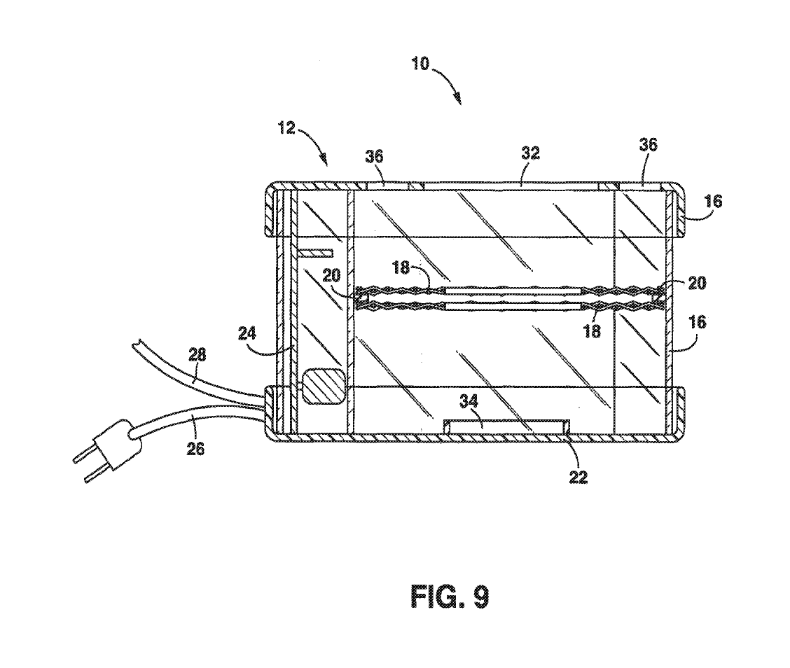

Within the housing 16 is one or more electrified metal conductors 18 that are about 4 to 8 inches across, have a 2 to 5 inch hole in the middle to accommodate the bed leg 14 and the leg anchor 34. The electrified metal conductors 18 are comprised of an upper electrified metal conductor 18 and a lower electrified metal conductor 18 that are electronically insulated/spaced away from each other by one or more insulators 20. The conductors 18 and/or insulators 20 maybe planer structures, as shown in FIGS. 6 and 7, stacked over each other, as shown in FIG. 4. Pairs of conductors 18 preferably have opposite polarities. The voltage potential between a pair of conductors is preferably such that a bug walking across the surface created with the stack of the conductors will cause a current to travel through the bug. Both the upper and lower conductors 18 have holes through the center of them. The holes in both conductors 18 are of sufficient size to allow a bed leg 14 to pass through the holes. Both the upper and lower conductors 18 are secured within the housing 16, surrounded by the housing 16 perimeters.

The conductors 18 may have variable diameters/sizes to create a meandering pattern that bugs must traverse to make it through the individual unit 12 before reaching the bed leg 14. For example, the edges of the conductors 18 and insulators 20 could create an inclined ramp or stairs for the insects 30 to crawl, as opposed to the vertical wall shown in FIG. 4. This would be accomplished by differences of diameter of the conductors 18 and insulators 20. The shape of the perimeter of the housing 16, metal conductors 18 and insulators 20 may be circular, square, elliptical or rectangular or many other shapes, and the size of the conductors 18 may vary considerably. In any event, the units 12 create a 360 degree barrier around the bed leg so that bugs attempting to reach the leg 14 will be subject to electrocution. The conductors 18 may be solid plates or be formed from interwoven conductors 18.

The electrical components inside each unit are typical electrical components that are used in many other electronic devices. The electrical components in the preferred embodiment of the electronic insect barrier 10 and individual units 12 are designed to accept a low voltage input and then increase the voltage to a very high voltage that is sufficient to kill an insect 30 or bed bug 30 when it walks on or makes contact with the electrified metal conductors 18. In alternate embodiments of the device. the power may be supplied to the electrified metal conductors 18 directly from a high voltage source and without the need for voltage amplification.

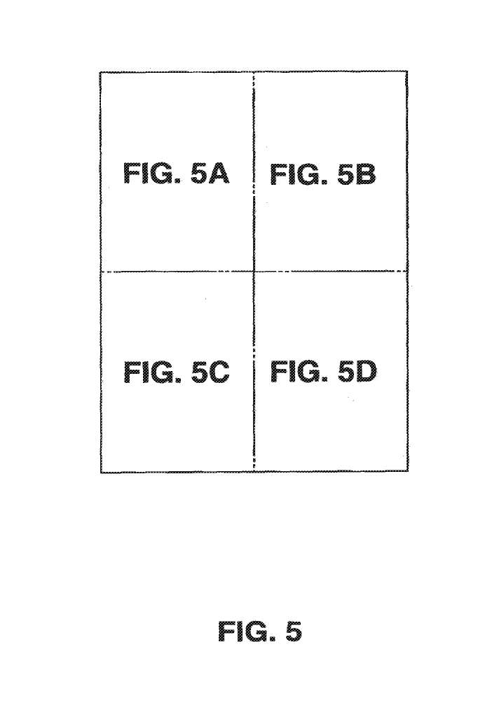

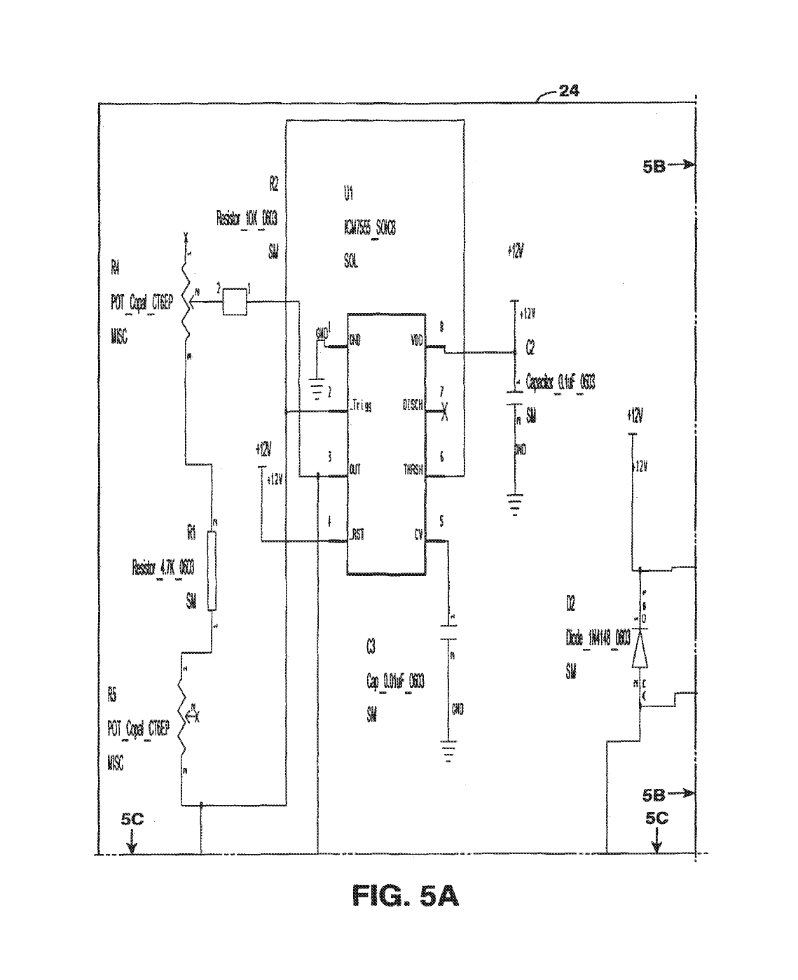

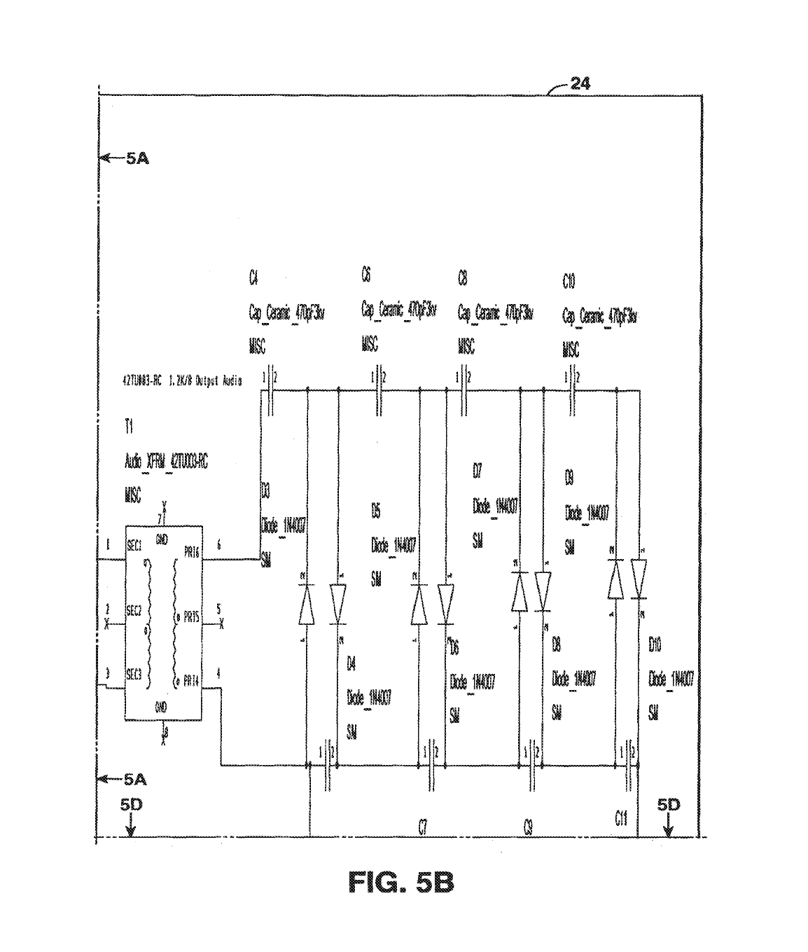

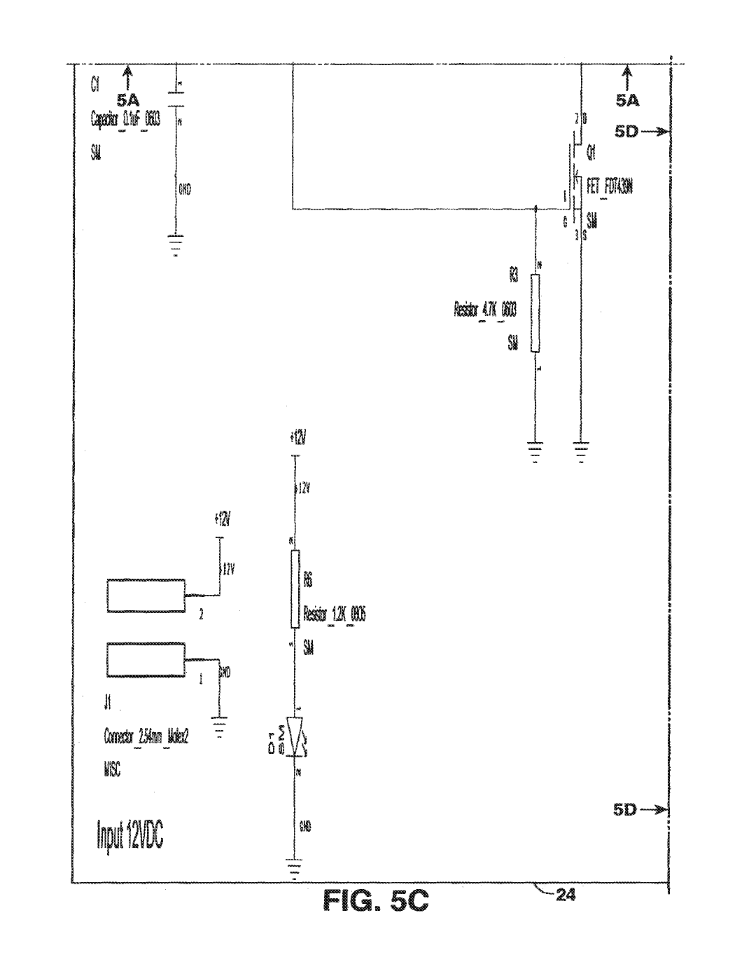

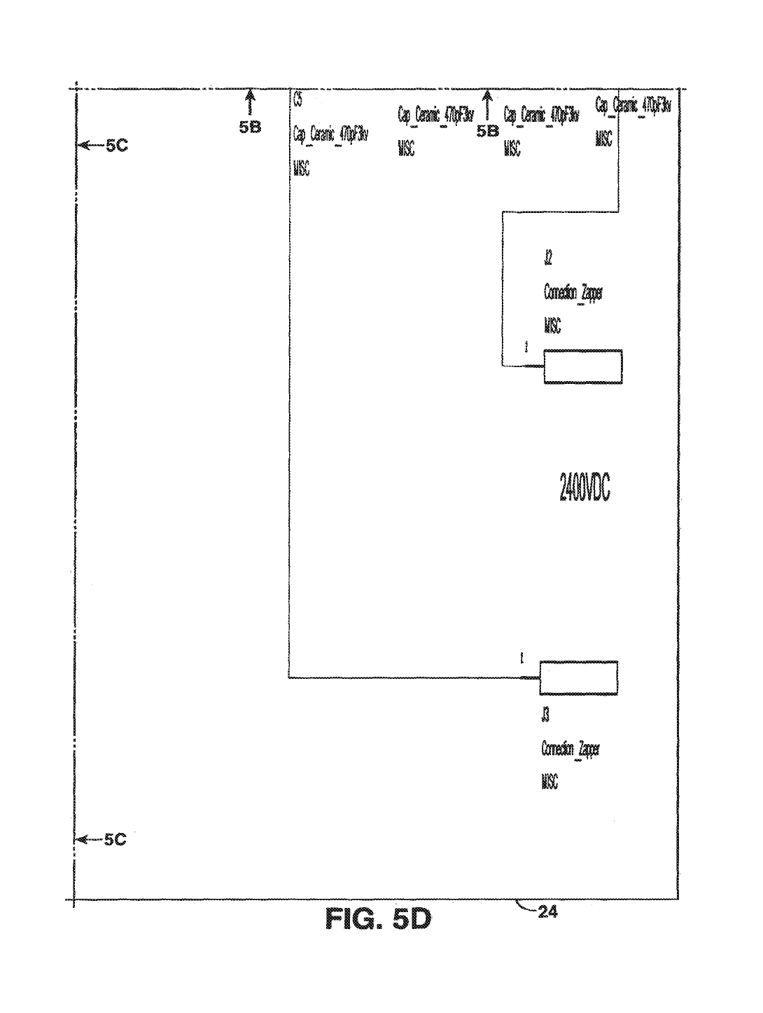

Referring to FIGS. 5 and 5A-5D, in one embodiment, 120 volts AC is dropped to 12 volts DC by a switching circuit. A square wave pulse train is created. The circuit is tunable that the voltage can be adjusted in a range from approximately 200 volts to 2400 volts DC. Using alternating polarity two or more conductors 18 are wired in parallel. The insect 30 is exterminated by conducting current through its body when it comes in contact with the conductor pairs 18 on the side of the stack with exposed ends of the conductor 18 pairs.

The size and shape of the device to and individual units 12 and all its components can be varied by to accommodate different size and shape bed legs 14. The electrical components may be varied or changed to make the device more safe and effective.

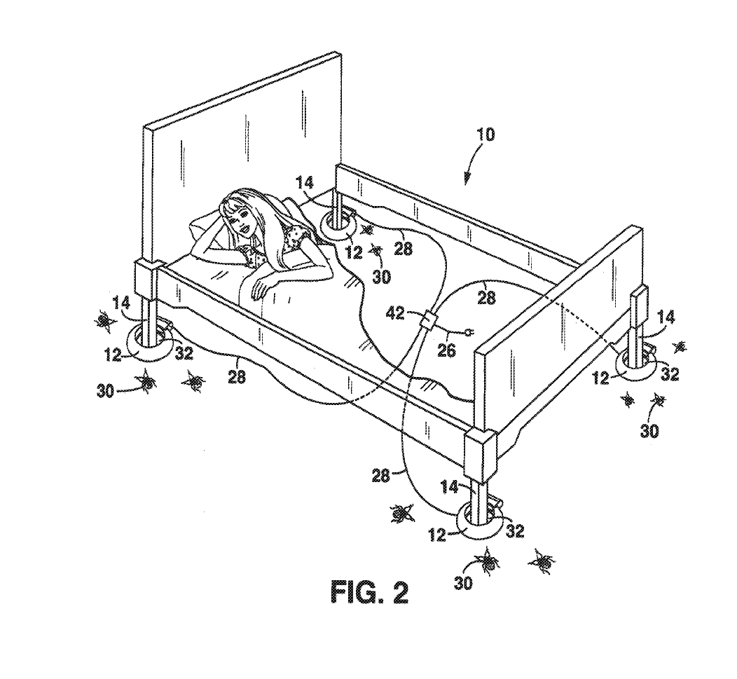

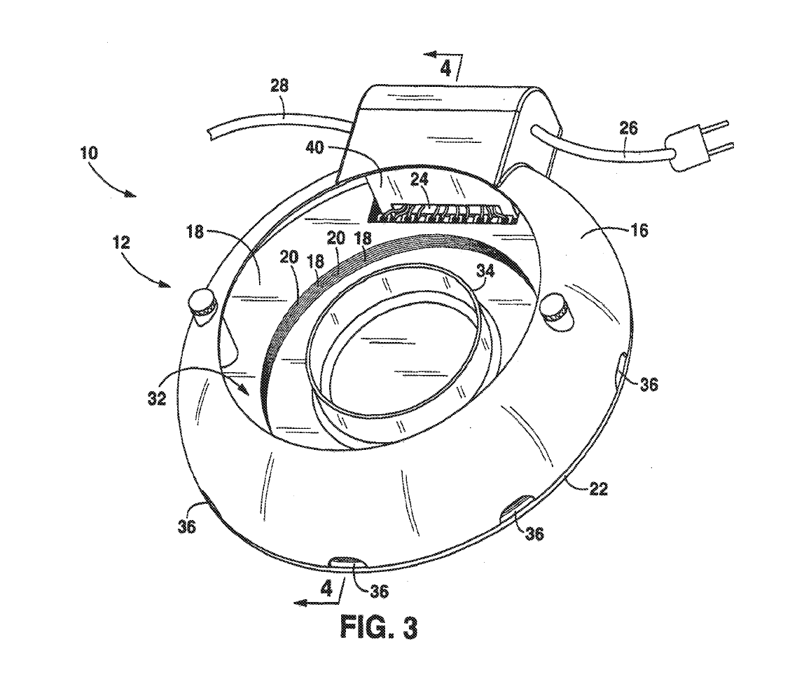

In one embodiment. as shown in FIG. 1, the electronic insect barrier 10 uses four individual units 12 to surround four bed legs 14. Each individual unit 12 is plugged into and powered by a power cord 26 containing a single transformer 42 that plugs into an electrical wall outlet. Further variations of this invention may include four or more individual units 12, each of which has its own batteries for its power source. Additionally, the units 12 may plug into and derive power from a hub transformer 42 by network connection 28, allowing the device 10 to be scalable, as shown in FIG. 2.

The electronic circuit 24 is shielded from contact by the circuit board cover 40. The power on indicator 38 alerts the on looker an electronic insect barrier 10 or individual unit 12 is operational.

### Alternate Embodiments

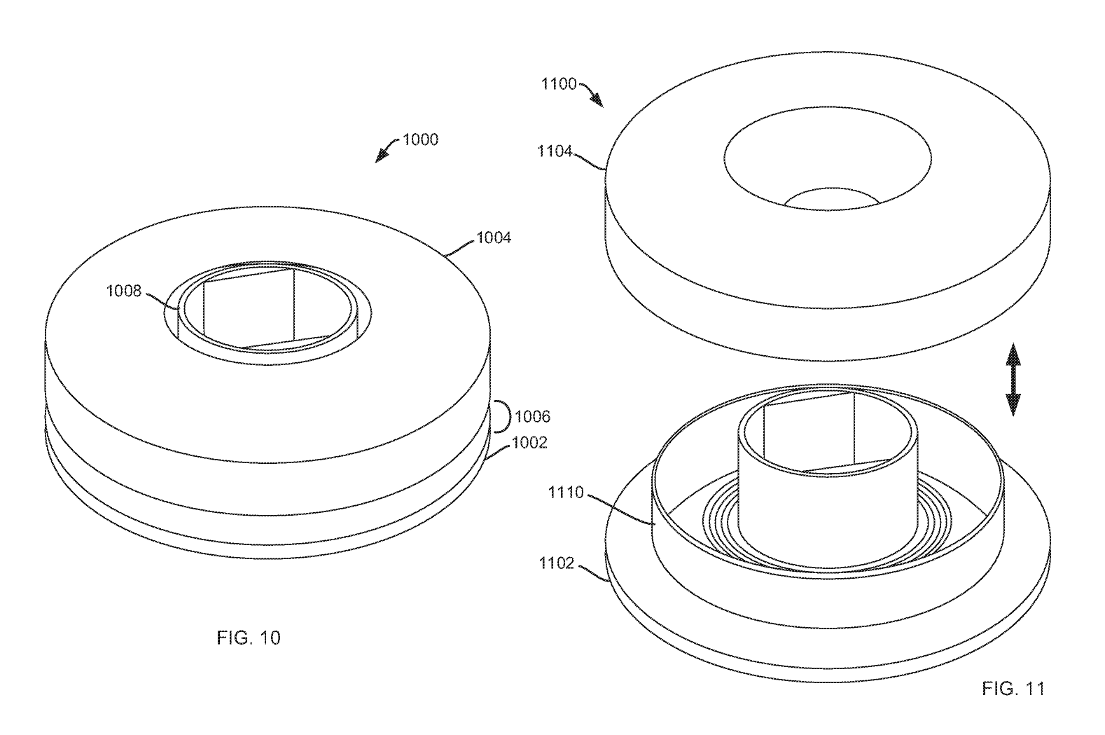

It may be appreciated that other electronic insect barriers may be configured to provide safe and effective protection from insect incursion. FIG. 10 is an illustrative representation of electronic insect barrier 1000 in accordance with embodiments of the present invention. As illustrated, electronic insect barrier embodiments include base 1002 and removable cover 1004. In operation, crawling insects may enter opening 1006 and may be trapped and exterminated within by electric shock. Electronic insect barrier embodiments may be placed on a furniture leg through opening defined by inner barrier 1008. In this manner, crawling insects may be prevented from infesting the furniture. While embodiments disclosed herein are circular in profile as illustrated, any profile or shape may be utilized without departing from embodiments provided herein. For example, a square profile, a triangle profile, a multi-sided profile, an oval profile, and a semi-circular profile may be utilized in embodiments without limitation.

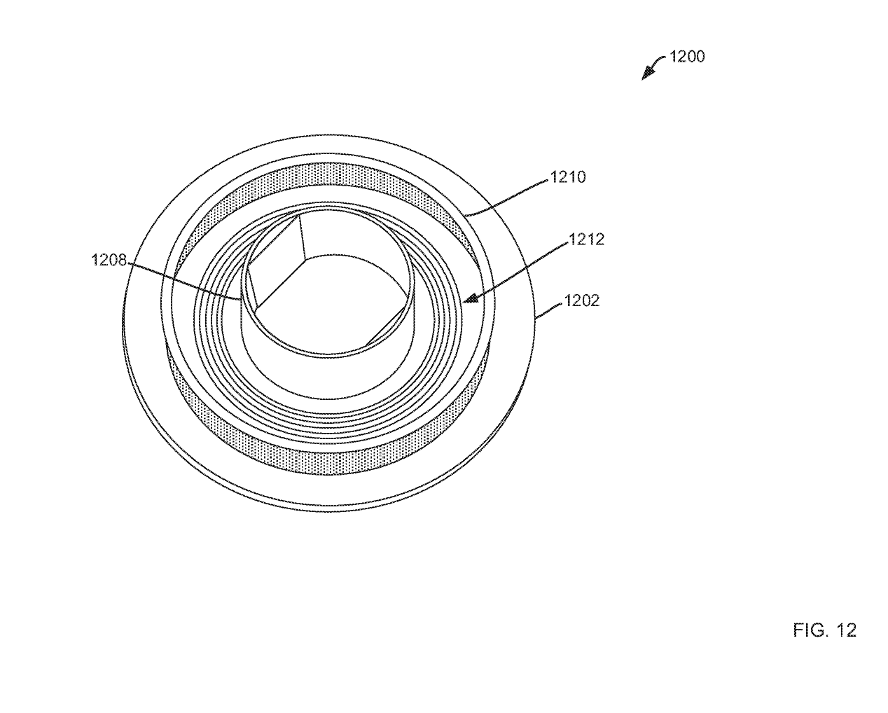

FIG. 11 is an illustrative representation of an electronic insect barrier 1100 with removable cover off in accordance with embodiments of the present invention. As noted above, electronic insect barrier embodiments include base 1102 and removable cover 1104. Removable cover 1104 may be removed to clear exterminated insects from the trap cavity formed by removable cover 1104 and perimeter barrier 1110. In embodiments, when removable cover 1104 is removed, power to the electrodes may be terminated as a safety measure.

FIG. 12 is an illustrative representation of an electronic insect barrier 1200 with removable cover off in accordance with embodiments of the present invention. As illustrated, electronic insect barrier embodiments include base 1202, perimeter barrier 1210, and inner barrier 1208. Further illustrated are electrodes 1212 which may be powered by a separate or integrated power unit. In some embodiments, a single power unit may provide power to a number of electronic insect barriers.

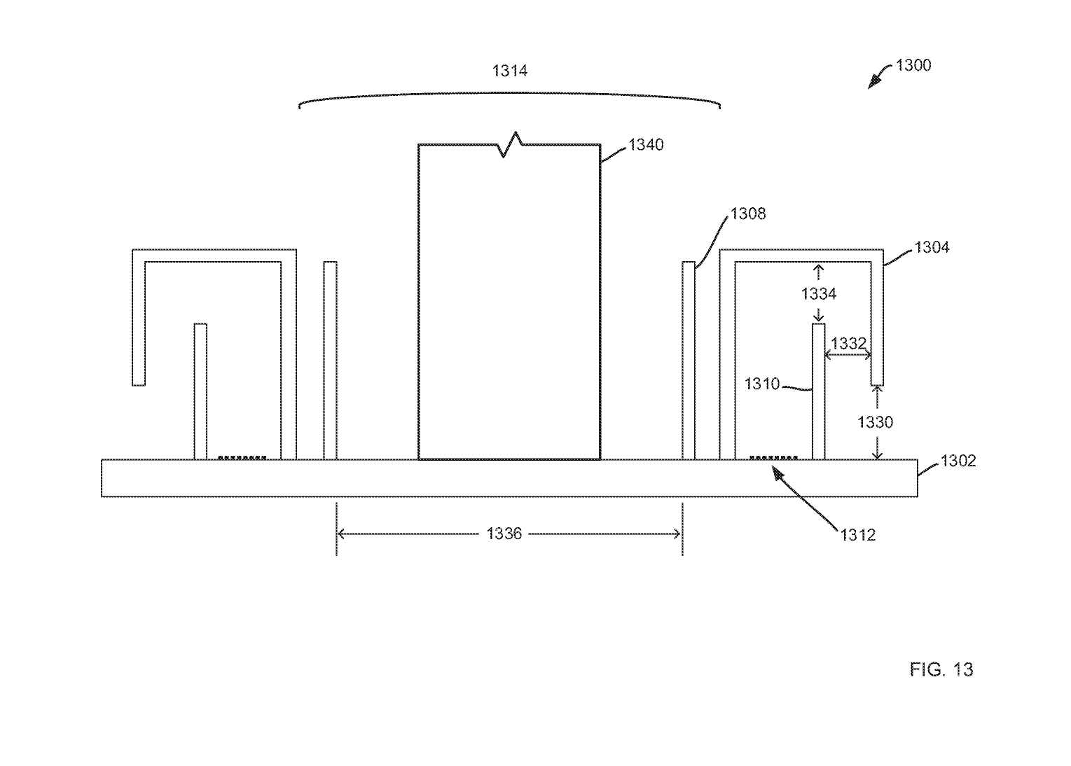

FIG. 13 is an illustrative representation of a cross-sectional view of an electronic insect barrier 1300 with removable cover in accordance with embodiments of the present invention. As illustrated, electronic insect barrier embodiments include base 1302, which is defined by an edge. In embodiments, base 1302 may have a substantially planar surface and may be of any size or shape without limitation. Further illustrated is perimeter barrier 1310 that extends upwardly from base 1302. It may be seen that the perimeter is inward of the edge. Embodiments include removable cover 1304 that defines a trap cavity with perimeter barrier 1310 and defines an inner opening 1314. It may be seen that removable cover 1304 extends upwardly from base 1302 starting inward of and along perimeter barrier 1310. Removable cover 1304 then extends outwardly toward the edge and then downwardly toward base 1302 terminating at a hanging edge outward of and along perimeter barrier 1310.

Present embodiments prevent infestation of crawling insects in at least two ways. First, embodiments provide a physical barrier. Many insects may crawl or jump over conventional physical barriers. In present embodiments, a perimeter barrier is provided that insects may crawl over. However, dimensionally, perimeter barriers are physically isolated to a degree that does not allow an insect to jump from one portion of the insect barrier to another. For example, in embodiments illustrated the hanging edge terminates at least approximately 1.0 inch (1330) from base 1302. In addition, in embodiments illustrated the hanging edge terminates at least approximately 1.0 inch (1332) from perimeter barrier 1310. Still further, a top edge of perimeter barrier 1310 terminates at least approximately 1.0 inch (1334) from bottom surface of removable cover 1304. In some embodiments, the distance may be increased depending on the type of insect anticipated. For example, in one embodiment it is theorized that some insects may jump a distance of not more than 1.5 inches. In this case, all isolation dimensions may be 1.5 inches or more. In other cases, an insect may have a leg length that cannot span a particular distance, such as 1.0 inch for example. In addition, a distance may be selected that prevents incursion of insects while also preventing the touching of electrodes 1312 by a human or pet.

In addition to the perimeter barrier, electrodes 1312 may provide a second barrier. Electrodes 1312 may be located along base 1302 inward of perimeter barrier 1310 and within the trap cavity. In embodiments, electrodes may be interleaved with insulators. Any number of electrodes energized by a power unit may be utilized in embodiments. For example, in one embodiment, more than two electrodes may be utilized in order to more effectively shock and exterminate bugs. In some embodiments eight or more electrodes may be utilized. A wider array of electrodes may ensure that insects may not jump across electrodes to avoid being shocked or exterminated. In one embodiment, electrodes may have a width of approximately 0.047 inches and insulation may have a width of approximately 0.063 inches. As may be appreciated, a wide range of voltages may be provided across electrode embodiments. For example, in one embodiment, an electrical potential may be provided in a range of approximately 1500 to 2000 VDC. In another embodiment, an electrical potential may be approximately 1700 VDC as for example for exterminating bed bugs. At these voltages, an insect may be shocked and exterminated. In other embodiments a lower voltage may be useful for stunning an insect. For example, in some embodiments, an electrical potential may be provided in a range of approximately 500 to 700 VDC. It may be that a lower electrical potential may be desirable due to safety considerations. In still other embodiments, dual voltages may be useful such that some of the electrodes may have an electrical potential in a range of approximately 1500 to 2000 VDC, while other electrodes may have an electrical potential in a range of approximately 500 to 700 VDC. In addition, while electrodes may be placed on the base as illustrated, in some embodiments, some electrodes may be located along the perimeter barrier (not shown).

Further illustrated is inner barrier 1308 that extends upwardly from base 1302 and located inward of removable cover 1304. It may be seen that inner barrier 1308 defines a space for receiving a furniture leg 1340. In embodiments, furniture legs may include bed legs, table legs, or any other leg known in the art without limitation. In embodiments, the space defined by inner barrier 1308 has an open cross-section of at least approximately 4 inches (1336).

As may be appreciated, embodiments may be applied to any or all furniture legs to create crawling insect resistant furniture. Thus, for example, a bed may be provided and a number of electronic insect barriers may be located along the bottom of each bed leg. After an insect is shocked and exterminated, the removable cover may be lifted and the trap cavity cleaned of insects.

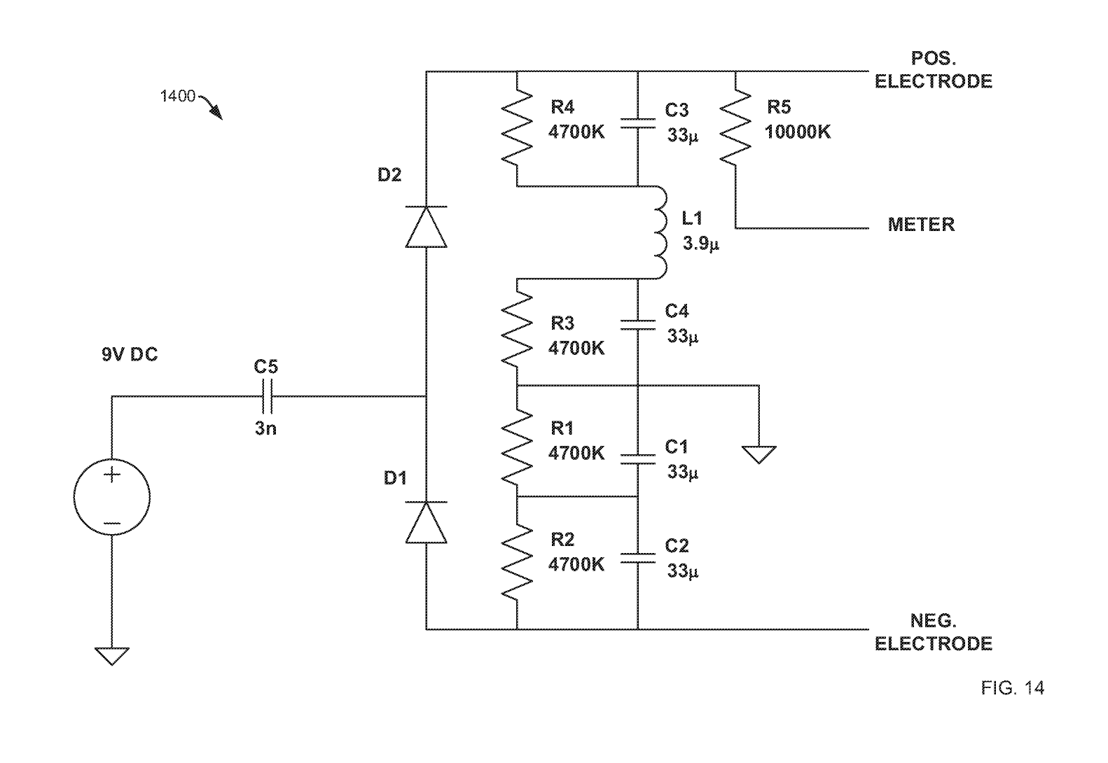

FIG. 14 is an illustrative schematic diagram 1400 of a device electronic circuit in accordance with embodiments of the present invention. Those skilled in the art will recognize that the values illustrated for the schematic diagram are presented for clarity in understanding embodiments provided herein and should not be construed as limiting. A range of values for the circuit may be equally utilized for powering electrodes without departing from embodiments herein.

While this invention has been described in terms of several embodiments, there are alterations, permutations, and equivalents, which fall within the scope of this invention. It should also be noted that there are many alternative ways of implementing the methods, computer program products, and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. An electronic insect barrier comprising:
a base defined by an edge;
a perimeter barrier extending upwardly from the base, the perimeter barrier located inward of the edge;
a removable cover that defines a trap cavity and defines an inside opening, wherein
the removable cover extends upwardly from the base starting inward of and along the perimeter barrier, wherein
the removable cover extends outwardly toward the edge, and wherein
the removable cover extends downwardly toward the base terminating at a hanging edge outward of and along the perimeter barrier;
a plurality of electrodes located at least along the base inward of the perimeter barrier and within the trap cavity; and
an inner barrier extending upwardly from the base, the inner barrier located inward of the removable cover, the inner barrier defining a space for receiving a furniture leg.

2. The electronic insect barrier of claim 1, wherein the plurality of electrodes are interleaved with a plurality of insulators.

3. The electronic insect barrier of claim 1, wherein some of the plurality of electrodes are located along the perimeter barrier.

4. The electronic insect barrier of claim 1, further comprising a power unit that creates an electrical potential between pairs of the plurality of electrodes.

5. The electronic insect barrier of claim 4, wherein the electrical potential is in a range of approximately 1500 to 2000 VDC.

6. The electronic insect barrier of claim 4, wherein the electrical potential is approximately 1700 VDC.

7. The electronic insect barrier of claim 1, wherein the hanging edge terminates at least approximately 1.0 inch from the base.

8. The electronic insect barrier of claim 1, wherein the hanging edge terminates at least approximately 1.0 inch from the perimeter barrier.

9. The electronic insect barrier of claim 1, wherein a top edge of the perimeter barrier terminates at least approximately 1.0 inch from a bottom surface of the removable cover.

10. The electronic insect barrier of claim 1, wherein the space defined by the inner barrier has an open cross-section of at least approximately 4.0 inches.

11. A insect resistant bed comprising:
a bed having a plurality of bed legs; and
a plurality of electronic insect barriers positioned along each of the plurality of bed legs, each electronic insect barrier comprising,
a base defined by an edge,
a perimeter barrier extending upwardly from the base, the perimeter barrier located inward of the edge,
a removable cover that defines a trap cavity and defines an inside opening, wherein
the removable cover extends upwardly from the base starting inward of and along the perimeter barrier, wherein
the removable cover extends outwardly toward the edge, and wherein
the removable cover extends downwardly toward the base terminating at a hanging edge outward of and along the perimeter barrier;
a plurality of electrodes located at least along the base inward of the perimeter barrier and within the trap cavity, and
an inner barrier extending upwardly from the base, the inner barrier located inward of the removable cover, the inner barrier defining a space for receiving one of the plurality of bed legs.

12. The insect resistant bed of claim 11, further comprising a power unit that creates an electrical potential between pairs of the plurality of electrodes.

13. The insect resistant bed of claim 12, wherein the electrical potential is in a range of approximately 1500 to 2000 VDC.

14. The insect resistant bed of claim 12, wherein the electrical potential is approximately 1700 VDC.

15. A method for preventing crawling insects from entering a bed comprising:
providing a bed having a plurality of bed legs; and
providing a plurality of electronic insect barriers each positioned along a bottom of each of the plurality of bed legs, wherein each of the plurality of electronic insect barriers comprise,
a base defined by an edge,
a perimeter barrier extending upwardly from the base, the perimeter barrier located inward of the edge,
a removable cover that defines a trap cavity and defines an inside opening, wherein
the removable cover extends upwardly from the base starting inward of and along the perimeter barrier, wherein
the removable cover extends outwardly toward the edge, and wherein
the removable cover extends downwardly toward the base terminating at a hanging edge outward of and along the perimeter barrier;
a plurality of electrodes located at least along the base inward of the perimeter barrier and within the trap cavity, and
an inner barrier extending upwardly from the base, the inner barrier located inward of the removable cover, the inner barrier defining a space for receiving one of the plurality of bed legs.

16. The method of claim 15, further comprising a power unit that creates an electrical potential between pairs of the plurality of electrodes.

17. The method of claim 16, wherein the electrical potential is in a range of approximately 1500 to 2000 VDC.

18. The method of claim 16, wherein the electrical potential is approximately 1700 VDC.

19. The method of claim 16, further comprising:
shocking the crawling insect when the crawling insect touches a pair of the plurality of electrodes.

20. The method of claim 16, further comprising:
lifting the removable cover to access the trap cavity; and
cleaning the trap cavity.
